(19) United States
(12) Patent Application Publication
(10) Pub. No.: US 2026/0260774 A1
(43) Pub. Date: Sep. 3, 2026

(54) METHODS AND APPARATUSES FOR AXIAL BEAM-FREE ELECTROMAGNETICALLY-INDUCED-TRANSPARENCY COOLING

(71) Applicant: IonQ, Inc., College Park, MD (US)

(72) Inventor: Michael Lurie GOLDMAN, University Park, MD (US)

(21) Appl. No.: 18/990,900

(22) Filed: Dec. 20, 2024

Related U.S. Application Data
(60) Provisional application No. 63/613,354, filed on Dec. 21, 2023.

(51) Int. Cl. G21K 1/20; G06N 10/40

(52) U.S. Cl. CPC G21K 1/20; G06N 10/40

(57) ABSTRACT

Aspects of the present disclosure may include methods and systems for trapping an ion chain along a first axis, the ion chain including a plurality of trapped ions, applying a magnetic field, to the ion chain, along a second axis perpendicular to the first axis, applying a first beam, to the ion chain, at a first angle relative to the first axis, the first beam including two or more first polarization components, and applying a second beam, to the ion chain, at a second angle relative to the first axis, the second beam including two or more second polarization components, the first angle and the second angle being non-parallel to the first axis or the second axis.

### CROSS REFERENCE TO RELATED APPLICATIONS

The current application claims priority to, and the benefit of United States Provisional Application No. 63/613,354 filed December 21, 2023 and entitled “METHODS AND APPARATUSES FOR AXIAL BEAM-FREE ELECTROMAGNETICALLY-INDUCED-TRANSPARENCY COOLING,” the contents of which are hereby incorporated by reference in their entireties.

### BACKGROUND

In a quantum information processing (QIP) system, the entanglement of trapped ions in an ion chain is used for performing logic and/or quantum computation. The quantum states of the trapped ions represent the computational states for quantum logic. The trapped ions in the ion chain may be cooled. One mechanism that may be used to cool the trapped ions is by using techniques based on electromagnetically-induced transparency (EIT). However, there are restrictions associated with the application of these techniques. Therefore, it may be important to implement EIT cooling with fewer restrictions.

### SUMMARY

The following presents a simplified summary of one or more aspects to provide a basic understanding of the disclosure. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure may include methods and systems for trapping an ion chain along a first axis, the ion chain including a plurality of trapped ions, applying a magnetic field, to the ion chain, along a second axis perpendicular to the first axis, applying a first beam, to the ion chain, at a first angle relative to the first axis, the first beam including two or more first polarization components, and applying a second beam, to the ion chain, at a second angle relative to the first axis, the second beam including two or more second polarization components, the first angle and the second angle being non-parallel to the first axis or the second axis.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal, or chain, in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates examples of electromagnetically-induced-transparency (EIT) cooling schemes according to aspects of the present disclosure.

FIG. 5 illustrates a table showing example polarization components for EIT cooling according to aspects of the present disclosure.

FIG. 6 illustrates a scheme for dual beam Doppler cooling according to aspects of the present disclosure.

FIG. 7 illustrates examples of an EIT cooling scheme for certain ions according to aspects of the present disclosure.

FIG. 8 illustrates an example of a scheme for two beam EIT cooling for trapped ions with a nuclear spin of I=3/2 according to aspects of the present disclosure.

FIG. 9 illustrates an example of a method for implementing EIT cooling according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form to avoid obscuring such concepts.

A quantum information processing (QIP) system may include using electromagnetically-induced-transparency (EIT) cooling to cool the motional modes of the parcel in the manipulation zone while not disturbing the qubit states of the ions in the other parcels. Each parcel may include ions that are spatially separated along the axis of the ion chains. An existing approach to EIT cooling uses one beam that is purely π-polarized to achieve EIT cooling. However, such configuration requires the beam to propagate axially along the trap. Using this EIT approach would cause this beam to inevitably address the idling parcels. While it may be possible to shelve those idling parcels in the D manifold to avoid/reduce the impact of the beam, such shelving would lead to appreciable subspace leakage errors due to the D state’s finite lifetime.

In some aspects, for efficient cooling, all three polarization components (σ⁺, σ⁻, and π components) may be present in at least one beam. As such, both beams cannot approach the ion chain either parallel or perpendicular to the magnetic field. However, one may approach the ion chain parallel and the other perpendicular. The relative k-vector between the two or more EIT beams may have a significant projection on the direction of the motional modes for cooling. For example, if the chain axis is oriented along y-axis of a cartesian coordinate, beams approaching the chain from the 135º angle (vector [(-1, 1) (0, 0)]) and the 45º (vector [(1, 1) (0, 0)]) would have a relative k-vector oriented along the x-axis. As such, the axial motional modes may not be cooled efficiently. In another example, beams approaching the chain from the 135º angle and the 315º angle (vector [(1, -1) (0, 0)]) may have a relative k-vector oriented in such a way that both axial motional modes and radial motional modes are cooled efficiently.

An aspect of the present disclosure includes a scheme for EIT cooling of trapped ions (e.g., Ba-133 and/or Ba-135/137) that does not require one beam to have pure π polarization. An advantage associated with the present scheme includes eliminating the need to have a beam propagate axially along the trap, which would remove the most obvious blocker to storing the idle chains in S instead of D. Architecturally, this may provide substantially more flexibility in implementing QIP systems.

In some aspects, the present scheme may allow multiple chains of a QIP system to be cooled separately within the same chamber.

In the EIT cooling scheme, two lasers of different polarizations are applied in such a way that there is a coherent superposition of two ground states that is dark to excitation, but the lasers can excite the ions if they also remove a quantum of excitation from a motional mode in the process. In this way, the motional modes are cooled, and the ions settle into the dark superposition state once most and/or all excitations have been removed from the relevant motional modes.

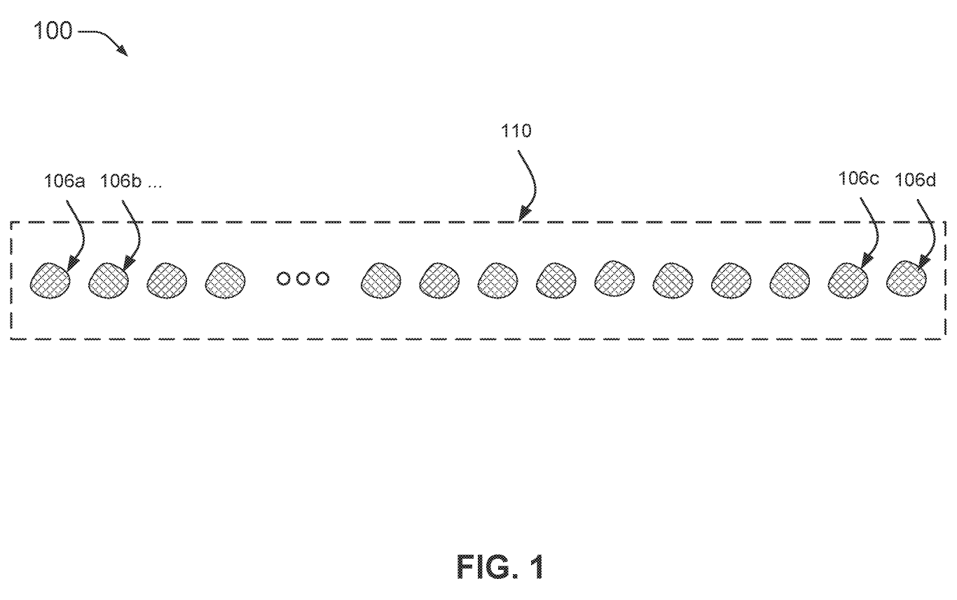

Example QIP systems that may implement aspects of the present disclosure are shown in FIGS. 1-3.

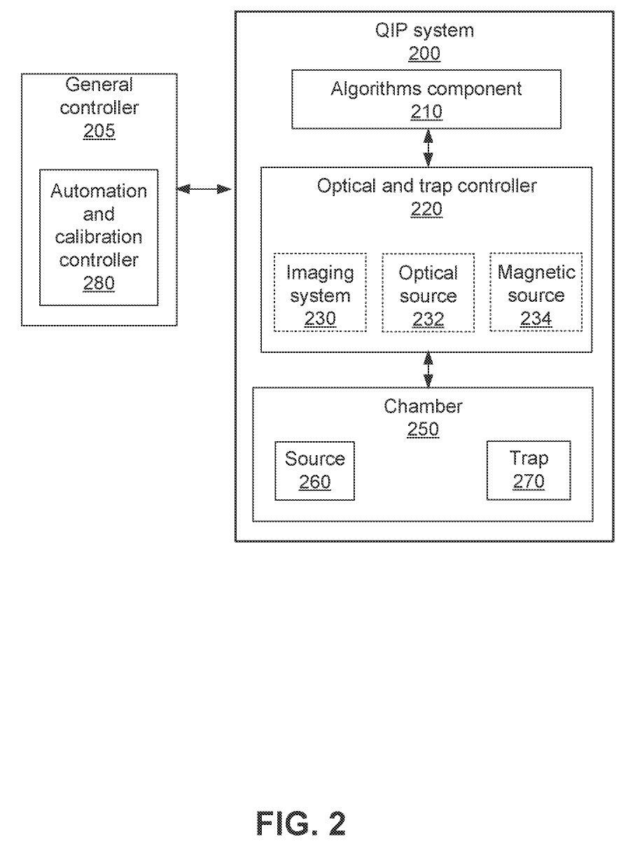

FIG. 1 shown below illustrates a diagram 100 with multiple atomic ions 106 (e.g., atomic ions 106a, 106b, …, 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be barium ions (e.g., Ba-133 and/or Ba-135/137) or Ytterbium ions (e.g., 171Yb+ ions), for example. The atomic ions are illuminated with laser (optical) radiation tuned to a resonance of the ions and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic ytterbium ions, neutral atoms, Rydberg atoms, different atomic ions or different species of atomic ions may also be used (such as one or more isotopes of barium, for example). The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure.

The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220. A related aspect to an imaging system collects the individual photon used for a photonic link.

The QIP system 200 may include an optical source 232 having one or more devices configured to provide laser beams for illuminating the trapped ions in the trap 270. The optical source 232 may include a light source configured to emit a laser beam. The optical source 232 may include an acousto-optic modulator (AOM) configured to modulate the phase, frequency, amplitude, or other optical characteristics of the light source as it passes through the AOM as known to one skilled in the art. The optical source 232 may include an acousto-optic deflector (AOD) configured to deflect the light source. The optical source 232 may include one or more active and/or passive optical components such as mirrors, resonators, amplifiers, crystals, etc.

The QIP system 200 may include a magnetic source 234 configured to apply one or more magnetic fields to the ions in the trap 270. The one or more magnetic fields may trap the ions, spatially move the ions, and/or perform other functions.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, the optical and trap controller 220, and/or the imaging system 230.

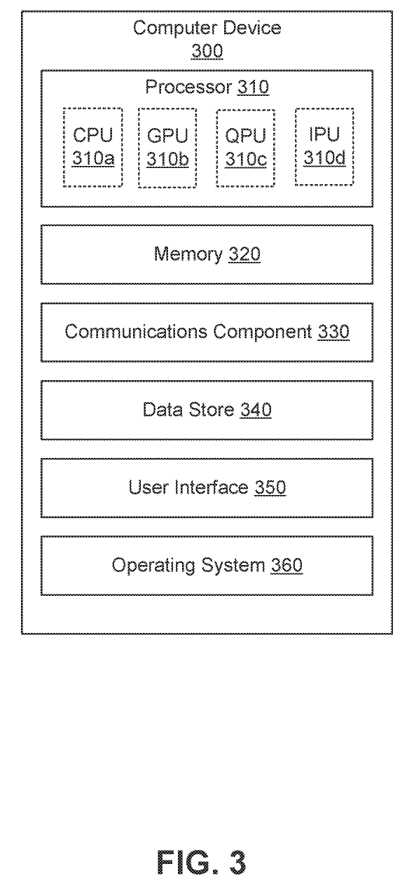

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300. This communications component may also include photonic links between QPUs in different computer devices.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

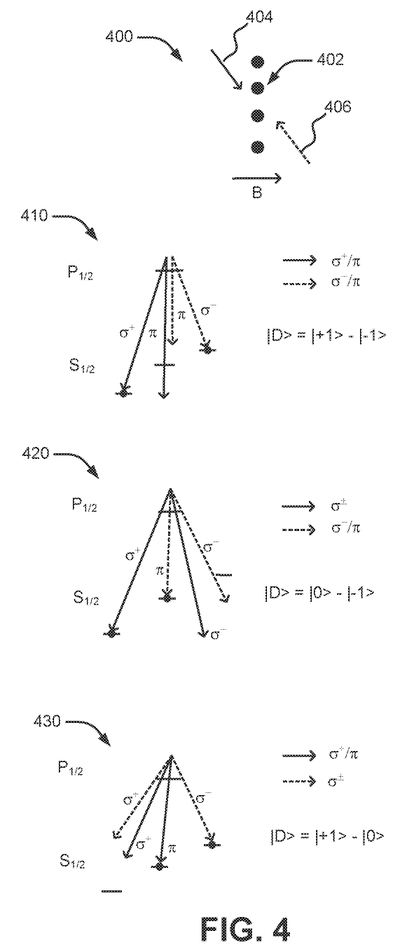

FIG. 4 illustrates three example schemes of EIT cooling for trapped ions with a nuclear spin of I=1/2 according to aspects of the present disclosure. In one aspect of the present disclosure, beams incident at an angle (e.g., 45°) with respect to the quantization axis, one can choose to eliminate any one of the three polarization components π, σ+, and σ-. To implement an EIT scheme, an aspect of the present disclosure includes choosing to eliminate a different polarization component from each of the two EIT beams, and those two polarization components that are present in only one beam define the dark state the beams produce. The sideband (e.g., 11.7 gigahertz (GHz)) can be put on whichever beam is convenient to repump from the 0 qubit state.

In the current implementation where one EIT beam has pure π polarization, it may be possible to choose between two different dark states depending on the relative frequency between the two beams. In one aspect, it may be possible to eliminate two polarization components from the π beam, which leaves two instead of one attainable dark state. Here, an aspect of the present disclosure includes using one dark state for a given set of beam polarizations.

A diagram 400 shows an aspect of the present disclosure. In the diagram 400, an ion chain 402 (such as the chain 110) may be under the application of a magnetic field B that is perpendicular to the axis of the ion chain 402. A first beam 404 carrying two or more first polarization components may be applied to the ion chain 402 at a first angle between 0º and 90º relative to the axis of the ion chain 402. A second beam 406 carrying two or more second polarization components (same or different than the two or more first polarization components) may be applied to the ion chain 402 at a second angle between 90º and 180º relative to the axis of the ion chain 402. The first beam 404 and/or the second beam 406 may be one or more laser beams from the optical source 232 being controlled by the optical and trap controller 220.

In some instances, the first beam 404 and the second beam 406 may approach the ion chain 402 from opposing directions. For example, the first beam 404 may approach the ion chain 402 at a 45º relative to the axis and the second beam 406 may approach the ion chain 402 at 135º relative to the axis.

In some instances, the first beam 404 and the second beam 406 may approach the ion chain 402 perpendicularly. For example, the first beam 404 may approach the ion chain 402 at a 45º relative to the axis (from one side) and the second beam 406 may approach the ion chain 402 at 45º relative to the axis (from the other side). Other configurations may also be implemented according to aspects of the present disclosure.

In some aspects of the present disclosure, a first scheme 410 may include the first beam 404 carrying the σ⁺ polarization component and the π polarization component. The first scheme 410 may include the second beam 406 carrying the σ⁻ polarization component and the π polarization component. The first beam 404 and the second beam 406 may impinge on the ion chain 402 at angles not parallel or orthogonal to the axis of the ion chain. As a result, the trapped ions in the ion chain 402 may have a dark state with components |1,+1□ and |1,-1□ that may be suitable for EIT cooling. The first beam 404 and the second beam 406 may be applied to the ion chain 402 contemporaneously.

In another aspect of the present disclosure, a second scheme 420 may include the first beam 404 carrying the σ⁺ polarization component and the σ⁻ polarization component. The first scheme 410 may include the second beam 406 carrying the σ⁻ polarization component and the π polarization component. The first beam 404 and the second beam 406 may impinge on the ion chain 402 at angles not parallel to the axis of the ion chain. As a result, the trapped ions in the ion chain 402 may have a dark state with components |1,0□ and |1,-1□ that may be suitable for EIT cooling.

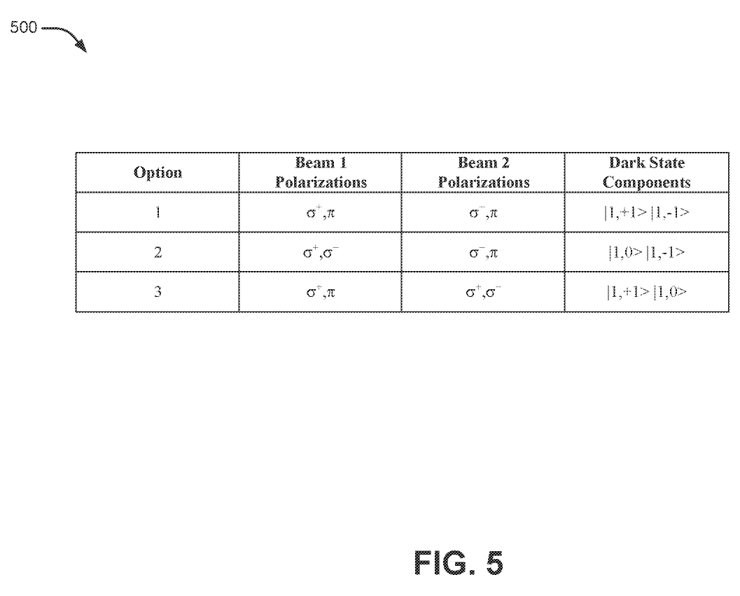

In certain aspect of the present disclosure, a third scheme 430 may include the first beam 404 carrying the σ⁺ polarization component and the π polarization component. The first scheme 410 may include the second beam 406 carrying the σ⁺ polarization component and the σ⁻ polarization component. The first beam 404 and the second beam 406 may impinge on the ion chain 402 at angles not parallel to the axis of the ion chain. As a result, the trapped ions in the ion chain 402 may have a dark state with components |1,+1> and |1,0> that may be suitable for EIT cooling. FIG. 5 illustrates a table 500 illustrating example beam configurations associated with FIG. 4.

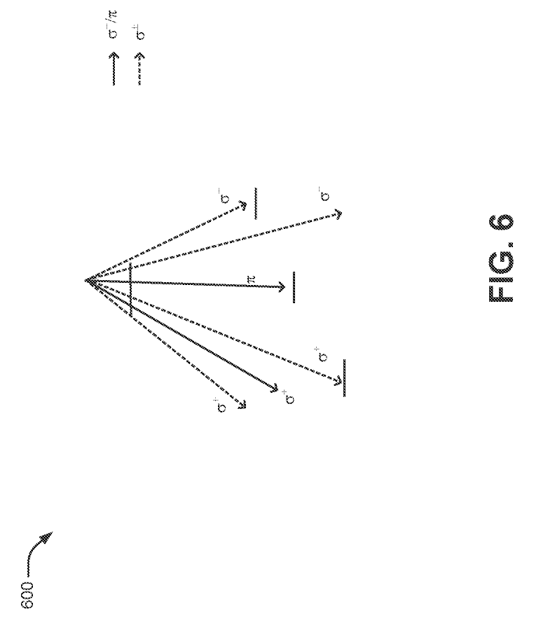

FIG. 6 illustrates a scheme for dual beam Doppler cooling according to aspects of the present disclosure. As described above, EIT cooling alone may include various combinations of the applied beams, such as the three schemes shown above. However, if beam polarizations were to support Doppler cooling at the first-order field-insensitive (FOFI) magnetic field, additional constraints may be imposed. In certain instances, at the FOFI magnetic field, the Zeeman splitting between the three states with m_{F} = 1 is approximately equal to the radiative decay rate γ. This would likely substantially degrade the performance of certain Doppler cooling scheme, which relies on pumping efficiently from all three states with a single optical tone that is detuned by approximately γ/2 to the red of the red-most transition. An alternative Doppler cooling scheme may be better suited to the FOFI magnetic field, in which two separate beams with π and σ+/σ- polarizations are applied to address the transitions from |1,0□ and |1,+1□/|1,-1〉 selectively. The π beam may be detuned by γ/2 to the red of the transition from |1,0□. In some aspects, two tones may be applied to the σ+/σ- beam, which may be detuned by γ/2 to the red of the transitions from |1,+1□ and |1,-1□. The tone may be blue-detuned by ~3γ/2 to the blue of the transition from |1,+1□ may heat weakly.

In some aspect, the dual-beam scheme may use the same polarizations as some EIT cooling schemes, so the same beams can be used for both purposes with suitable frequency tuning. The two beam Doppler cooling scheme may require the following: 1) each transition to have an optical tone detuned by ~γ/2 to the red, 2) forbid any transition from having an optical tone detuned by ~γ/2 to the blue, and 3) allow optical tones that are blue-detuned by ~3γ/2. A scheme 600 may illustrate a possible two beam Doppler cooling scheme: applying one tone to the beam with σ+/π polarization and two tones to the beam with σ+/σ- polarization. As such, the scheme 600 shown in FIG. 6 may be utilized for both two beam Doppler cooling and two beam EIT cooling according to aspects of the present disclosure.

In certain aspects, the schemes 410, 420, 430, 600 may be applicable to various trapped ions with a nuclear spin of I=1/2, such as barium 133.

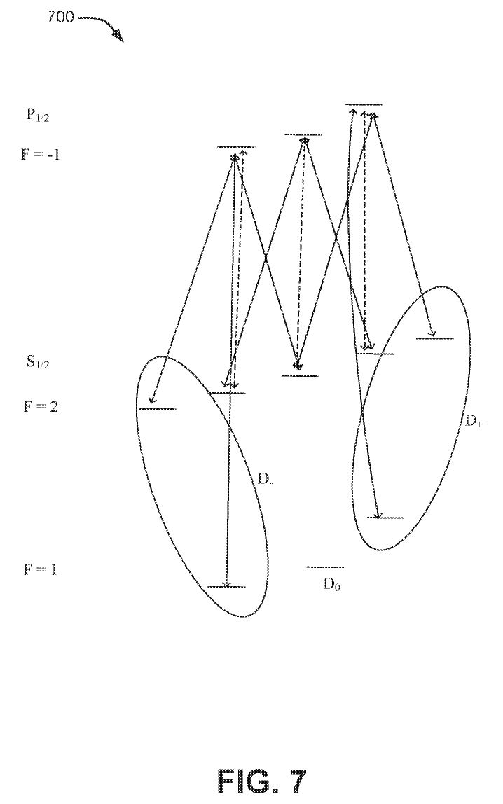

FIG. 7 illustrates another example of a scheme 700 for two beam EIT cooling according to aspects of the present disclosure. The scheme 700 may create two coherent dark states D₊ and D₋, as well as a trivial dark state D₀. The scheme 700 may be applicable to trapped ions with a nuclear spin of I=3/2, and therefore, that have a more complex hyperfine structure (compared to ions with a nuclear spin of I=1/2). Here, the EIT cooling may similarly be modified so that it does not require a single beam with pure π polarization. Here, the EIT dark states may span the S-state hyperfine splitting. By applying two beams with π and σ+/σ- polarizations (similar to the schemes described above) that respectively address the transitions from the F=1 and F=2 manifolds in S_{1/2} to the F’=1 manifold in P_{1/2}, the scheme 700 creates two coherent dark states comprised of either |1,□ and |2,+2□ or |1,-1□ and |2,-2□. However, the scheme 700 may have a trivial dark state |1,0□ because the transition to |1’,0’□ is not allowed. In order to address the trivial dark state, the scheme 700 may additionally apply microwaves or a 1762 nanometer (nm) beam to repump from the trivial dark state. The π-polarized beam, which addresses transitions from F=1, may be generated by applying an electro-optic modulator (EOM) sideband at the hyperfine frequency to a carrier that is tuned to transitions from F=2, which may simplify the technical implementation.

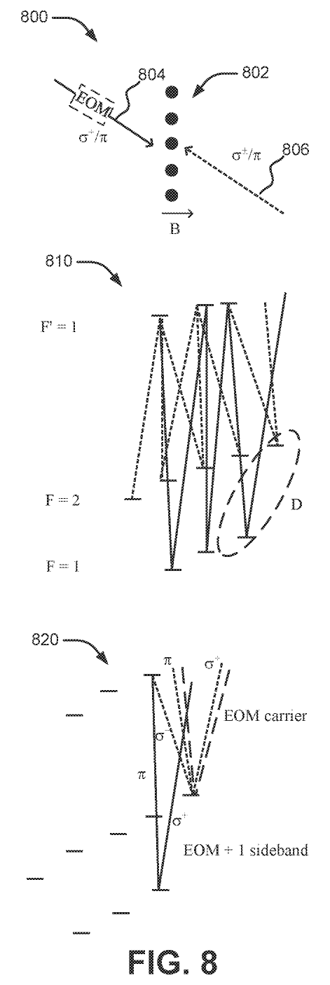

FIG. 8 illustrates another example of a scheme for two beam EIT cooling for trapped ions with a nuclear spin of I=3/2 according to aspects of the present disclosure. In a diagram 800, an ion chain 802 (such as the chain 110) may be under the application of a magnetic field B that is perpendicular to the axis of the ion chain 802. A first beam 804 carrying two or more first polarization components may be applied to the ion chain 802 at a first angle between 0º and 90º relative to the axis of the ion chain 802. A second beam 806 carrying two or more second polarization components (same or different than the two or more first polarization components) may be applied to the ion chain 802 at a second angle between 90º and 180º relative to the axis of the ion chain 802. The first beam 804 and the second beam 806 may be applied to the ion chain 802 contemporaneously.

In some aspects, FIG. 8 illustrates a scheme 810 that may eliminate the beam with pure π polarization here. The scheme 810 may add either σ+ or σ- to the π-polarized beam that addresses transitions from the F=1 manifold and still maintain one of the two coherent dark states. Further, adding the σ polarization removes the trivial dark state <1,0>, which eliminates the need to repump using microwaves or the 1762 nm beam. In some aspects, the scheme 810 may limit to using only one coherent dark state for a given polarization configuration. Because the EIT dark state in the scheme 810 spans the hyperfine splitting, the beam that addresses transitions from the F=2 manifold may either have only σ+ and σ- polarizations, or all three polarization components. In some aspects, Doppler cooling may be implemented for the scheme 810 according to the aspects of the present disclosure described above.

In some aspects, the scheme 820 illustrates the two beam EIT cooling scheme with the application of the EOM carrier and/or sideband. Here, the beam with a π polarization component and/or σ^{+/-} polarization components, which addresses transitions from F=1, may be generated by applying the EOM sideband at the hyperfine frequency to a carrier that is tuned to transitions from F=2, which may simplify the technical implementation.

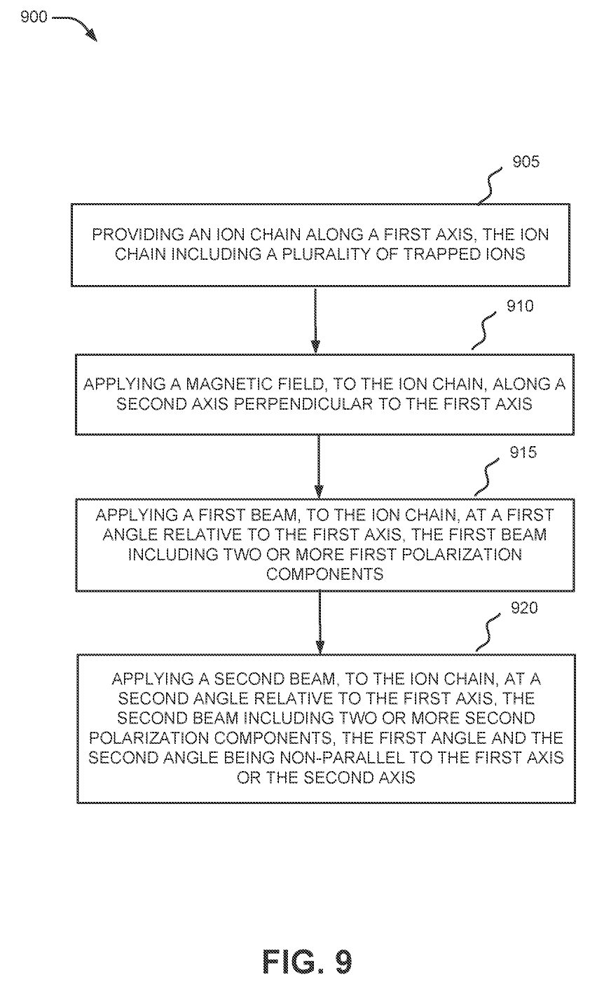

FIG. 9 illustrates an example of a method 900 of implementing EIT cooling according to aspects of the present disclosure. In general, it is noted that the method 900 may be performed by the general controller 205, the algorithm component 210, the optical and trap controller 220, the chamber 250, the processor 310, the memory 320, and/or one or more subcomponents of the QIP system 200 or the computer device 300 according to various exemplary aspects as described above. Specifically, the method 900 may be performed by one or more laser beams and/or electrodes associated with QIP system 200 and/or subcomponents of the QIP system 200.

Initially, at 905, the method 900 may trap an ion chain along a first axis, the ion chain including a plurality of trapped ions. For example, the magnetic source 234 and/or the chamber 250 may be configured to, and/or provide means for trapping an ion chain along a first axis, the ion chain including a plurality of trapped ions.

At 910, the method 900 may apply a magnetic field, to the ion chain, along a second axis perpendicular to the first axis. For example, the magnetic source 234, the general controller 205, the automation and calibration controller 280, the algorithm component 210, the optical and trap controller 220, the processor 310, the memory 320, and/or one or more subcomponents of the QIP system 200 or the computer device 300 may be configured to, and/or provide means for applying a magnetic field along a second axis perpendicular to the first axis.

At 915, the method 900 may apply a first beam, to the ion chain, at a first angle relative to the first axis, the first beam including two or more first polarization components. For example, the optical source 232, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for applying a first beam at a first angle relative to the first axis, the first beam including two or more first polarization components.

At 920, the method 900 may apply a second beam, to the ion chain, at a second angle relative to the first axis, the second beam including two or more second polarization components, the second beam including two or more second polarization components, the first angle and the second angle being non-parallel to the first axis or the second axis. For example, the optical source 232, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for applying a second beam at a second angle relative to the first axis, the second beam including two or more second polarization components.

Aspects of the present disclosure may include methods and systems for trapping an ion chain along a first axis, the ion chain including a plurality of trapped ions, applying a magnetic field along a second axis perpendicular to the first axis, applying a first beam at a first angle relative to the first axis, the first beam including two or more first polarization components, and applying a second beam at a second angle relative to the first axis, the second beam including two or more second polarization components.

Aspects of the present disclosure include the method and/or system above, wherein applying the first beam comprises applying the first beam at 45º on one side of the ion chain and applying the second beam comprises applying the second beam at 45º on another side of the ion chain.

Aspects of the present disclosure include any of the method and/or system above, wherein applying the first beam comprises applying the first beam at 45º on one side of the ion chain and applying the second beam comprises applying the second beam at 135º on another side of the ion chain.

Aspects of the present disclosure include any of the method and/or system above, wherein the two or more first polarization components comprises two or more of a σ+ component, a σ- component, or a π component and the two or more second polarization components comprises two or more of the σ+ component, the σ- component, or the π component.

Aspects of the present disclosure include any of the method and/or system above, wherein the two or more first polarization components comprises a σ+ component and a π component and the two or more second polarization components comprise two or more of the σ+ component and a σ- component.

Aspects of the present disclosure include any of the method and/or system above, wherein applying the first beam comprises applying an electro-optic modulator sideband at a hyperfine frequency to a carrier.

Aspects of the present disclosure include any of the method and/or system above, wherein the trapped ions are ions with a nuclear spin of I=3/2.

Aspects of the present disclosure include any of the method and/or system above, wherein the trapped ions are ions with a nuclear spin of I=1/2.

Aspects of the present disclosure include applying the first beam and the second beam contemporaneously.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of electromagnetically-induced-transparency (EIT) cooling, comprising:
trapping an ion chain along a first axis, the ion chain including a plurality of trapped ions;
applying a magnetic field, to the ion chain, along a second axis perpendicular to the first axis;
applying a first beam, to the ion chain, at a first angle relative to the first axis, the first beam including two or more first polarization components; and
applying a second beam, to the ion chain, at a second angle relative to the first axis, the second beam including two or more second polarization components, the first angle and the second angle being non-parallel to the first axis or the second axis.

2. The method of claim 1, wherein:
applying the first beam comprises applying the first beam at 45º on one side of the ion chain; and
applying the second beam comprises applying the second beam at 45º on another side of the ion chain.

3. The method of claim 1, wherein:
applying the first beam comprises applying the first beam at 45º on one side of the ion chain; and
applying the second beam comprises applying the second beam at 135º on another side of the ion chain.

4. The method of claim 1, wherein:
the two or more first polarization components comprises two or more of a σ⁺ component, a σ⁻ component, or a π component; and
the two or more second polarization components comprise two or more of the σ⁺ component, the σ⁻ component, or the π component.

5. The method of claim 4, wherein:
the two or more first polarization components comprises a σ⁺ component and a π component; and
the two or more second polarization components comprise two or more of the σ⁺ component and a σ⁻ component.

6. The method of claim 1, wherein the plurality of trapped ions are ions with a nuclear spin of I=1/2.

7. A quantum information processing (QIP) system, comprising:
a chamber configured to trap an ion chain along a first axis, the ion chain including a plurality of trapped ions;
a plurality of electrodes configured to apply a magnetic field, to the ion chain, along a second axis perpendicular to the first axis; and
a plurality of light sources configured to:
apply a first beam, to the ion chain, at a first angle relative to the first axis, the first beam including two or more first polarization components; and
apply a second beam, to the ion chain, at a second angle relative to the first axis, the second beam including two or more second polarization components, the second beam including two or more second polarization components, the first angle and the second angle being non-parallel to the first axis or the second axis.

8. The QIP system of claim 7, wherein:
applying the first beam comprises applying the first beam at 45º on one side of the ion chain; and
applying the second beam comprises applying the second beam at 45º on another side of the ion chain.

9. The QIP system of claim 7, wherein:
applying the first beam comprises applying the first beam at 45º on one side of the ion chain; and
applying the second beam comprises applying the second beam at 135º on another side of the ion chain.

10. The QIP system of claim 7, wherein:
the two or more first polarization components comprises two or more of a σ⁺ component, a σ⁻ component, or a π component; and
the two or more second polarization components comprise two or more of the σ⁺ component, the σ⁻ component, or the π component.

11. The QIP system of claim 10, wherein:
the two or more first polarization components comprises a σ⁺ component and a π component; and
the two or more second polarization components comprise two or more of the σ⁺ component and a σ⁻ component.

12. The QIP system of claim 7, wherein the plurality of trapped ions are ions with a nuclear spin of I=1/2.

13. A non-transitory computer readable medium having instructions that, when executed by one or more processors of a quantum information processing (QIP) system, cause the one or more processors to:
trap an ion chain along a first axis, the ion chain including a plurality of trapped ions;
apply a magnetic field, to the ion chain, along a second axis perpendicular to the first axis;
apply a first beam, to the ion chain, at a first angle relative to the first axis, the first beam including two or more first polarization components; and
apply a second beam, to the ion chain, at a second angle relative to the first axis, the second beam including two or more second polarization components, the first angle and the second angle being non-parallel to the first axis or the second axis.

14. The non-transitory computer readable medium of claim 13, wherein:
applying the first beam comprises applying the first beam at 45º on one side of the ion chain; and
applying the second beam comprises applying the second beam at 45º on another side of the ion chain.

15. The non-transitory computer readable medium of claim 13, wherein:
applying the first beam comprises applying the first beam at 45º on one side of the ion chain; and
applying the second beam comprises applying the second beam at 135º on another side of the ion chain.

16. The non-transitory computer readable medium of claim 13, wherein:
the two or more first polarization components comprises two or more of a σ⁺ component, a σ⁻ component, or a π component; and
the two or more second polarization components comprise two or more of the σ⁺ component, the σ⁻ component, or the π component.

17. The non-transitory computer readable medium of claim 16, wherein:
the two or more first polarization components comprises a σ⁺ component and a π component; and
the two or more second polarization components comprise two or more of the σ⁺ component and a σ⁻ component.

18. The non-transitory computer readable medium of claim 13, wherein the plurality of trapped ions are ions with a nuclear spin of I=1/2.
